(19) United States
(12) Patent Application Publication
(10) Pub. No.: US 2017/0180925 A1
(43) Pub. Date: Jun. 22, 2017

(54) Position Tracking System

(71) Applicant: Wal-Mart Stores, Inc., Bentonville, AR (US)

(72) Inventors: Robert C. Taylor, Rogers, AR (US); John Paul Thompson, Bentonville, AR (US); Donald High, Noel, MO (US)

(21) Appl. No.: 15/377,619

(22) Filed: Dec. 13, 2016

Related U.S. Application Data
(60) Provisional application No. 62/271,161, filed on Dec. 22, 2015.

(51) Int. Cl. H04W 4/02; H04W 4/04

(52) U.S. Cl. CPC H04W 4/02; H04W 4/04; H04W 84/12

(57) ABSTRACT

The present disclosure deals with a system and a method to track the position of moveable assets in a geographic location. Beacon generating devices, attached to moveable assets transmit beacon signals encoded with data. Sensors distributed around the geographic locations affixed to fixed assets detect the beacon signals and extract the encoded data. The Sensors transmit the data to a computing system. The computing system stores and analyzes the data. An event can be triggered by the computing system based on the analysis of the stored data.

### CROSS-REFERENCE TO RELATED PATENT APPLICATIONS

This application claims priority to U.S. Provisional Application No. 62/271,161 filed on Dec. 22, 2015, the contents of the application is hereby incorporated by reference in its entirety.

### BACKGROUND

Tracking assets and individuals as they move through a facility can be important both in terms of knowing where the assets and individuals are within the facility, but also in extracting information from such tracking which can be utilized to improve the performance of one or more systems that are implemented within the facility. However, it can be difficult to keep track of the assets and individuals as they move throughout the facility and can be difficult to make sense of what such movement means or how it affects the performance of one or more other systems.

### BRIEF DESCRIPTION OF DRAWINGS

Illustrative embodiments are shown by way of example in the accompanying drawings and should not be considered as a limitation of the present disclosure:

FIG. 1 is a block diagram illustrating beacon generating devices associated with moveable items within a facility and an interaction of the beacon generating devices with sensors distributed throughout the facility according to exemplary embodiments of the present disclosure;

FIG. 2 is a block diagram illustrating beacon generating devices associated with moveable items represented as shopping carts within a facility represented by a store and an interaction of the beacon generating devices with sensors distributed throughout the facility according to exemplary embodiments of the present disclosure;

FIG. 3 illustrates an exemplary environment for tracking movement of assets and/or individuals within a facility in accordance with exemplary embodiments of the present disclosure;

FIG. 4 is a block diagram of an example computing device for implementing exemplary embodiments of the present disclosure; and

FIG. 5 is a flowchart illustrating an exemplary process for tracking movement of assets and individuals in accordance with exemplary embodiments of the present disclosure;

### DETAILED DESCRIPTION

Described in detail herein are systems, methods, and non-transitory computer-readable media associated with tracking the position of assets and/or individuals as they move through a facility. In exemplary embodiments, beacon generating devices, associated with assets and/or individuals transmit beacon signals encoded with data. Geographically distributed sensors can detect the beacon signals transmitted by the beacon generating devices and can extract the encoded data included in the beacon signals. The sensors can transmit the extracted data to a computing system, which can store and analyze the data. One or more events can be triggered by the computing system based on the analysis of the data.

Exemplary embodiments of the present disclosure include systems, method, and non-transitory computer-readable media for position/location detection of beacon generating devices. For example, exemplary embodiments of the present disclosure can include a computing system having one processor and a non-transitory computer-readable medium, beacon generating devices configured to periodically transmit beacon signals encoded with data, and sensors distributed over a geographic area to track a location of the beacon generating devices. The beacon generating device can be stand-alone devices and/or can be embodied or integrated within one or more devices. For example, one or more of the beacon generating devices can be embodied in a mobile phone, portable digital assistant, laptop computer, tablet computer, or a wireless portable device. One or more of the beacon generating devices can be affixed to a moveable asset and/or can be associated with a user.

The sensors can disposed in different location throughout a building and/or can be configured to be communicatively coupled to the computing system and can be configured to be communicatively coupled to the beacon generating devices. For example, the sensors can be configured to be communicatively coupled to the computing system via a wireless (WiFi) access point. In exemplary embodiments, the sensors can include a first sensor configured to detect the beacon signals transmitted by one or more of the beacon generating devices in response to the one or more of the beacon generating devices being moved within a sensing range of the first sensor. In exemplary embodiments, the first sensor can extract the data from the beacon signals of the one or more beacon generating devices upon detection of the beacon signals and can transmit the data to the computing system. In response to receipt of the data, the computing system can be programmed to store the data in the non-transitory computer-readable medium, and trigger, via the processor, an event associated with at least one of the beacon generating devices based on the data.

In exemplary embodiments, in the data extracted based on the beacons signals output by the one or more beacon generating devices includes at least one of a time at which the beacon signals are detected by one or more of the sensors, a time at which the beacon signals are output/generated by the beacon generating devices, a type of asset or an individual to which the beacon generating device is associated, a type of device within which the beacon generating device is embodied, a duration of time the beacon signals are within the range of the sensor(s), and sensor locations at which the beacon signals are detected.

In response to an event being triggered based on the data extracted from the beacon generating devices, the computing system locates the moveable asset and/or individuals to which at least one of the beacon generating devices is associated, determines a predictive path of the one or more beacon generating devices, alerts one or more users of the location of at least one of the beacon generating devices based on the sensor location at which a beacon signal from the at least one of the beacon generating devices is detected, alerts the one or more users of a quantity of the beacon generating devices within the range of the sensor(s), and/or controls an operation of the moveable asset to which the at least one of the beacon generating devices is affixed.

In exemplary embodiments, in response to an event being triggered, the computing system determines that first and second beacon generating devices are associated with a single user and correlates the data extracted from the beacon signals generated by the first beacon generating device and the second beacon generating device. For example, the first beacon generating device can be affixed to a moveable asset and the second beacon generating device can be associated with a user (e.g., embodied in a wireless portable device carried by the user), and the computing system can determine the user is operating the moveable asset based on the beacon signals generated by the first and second beacon generating devices.

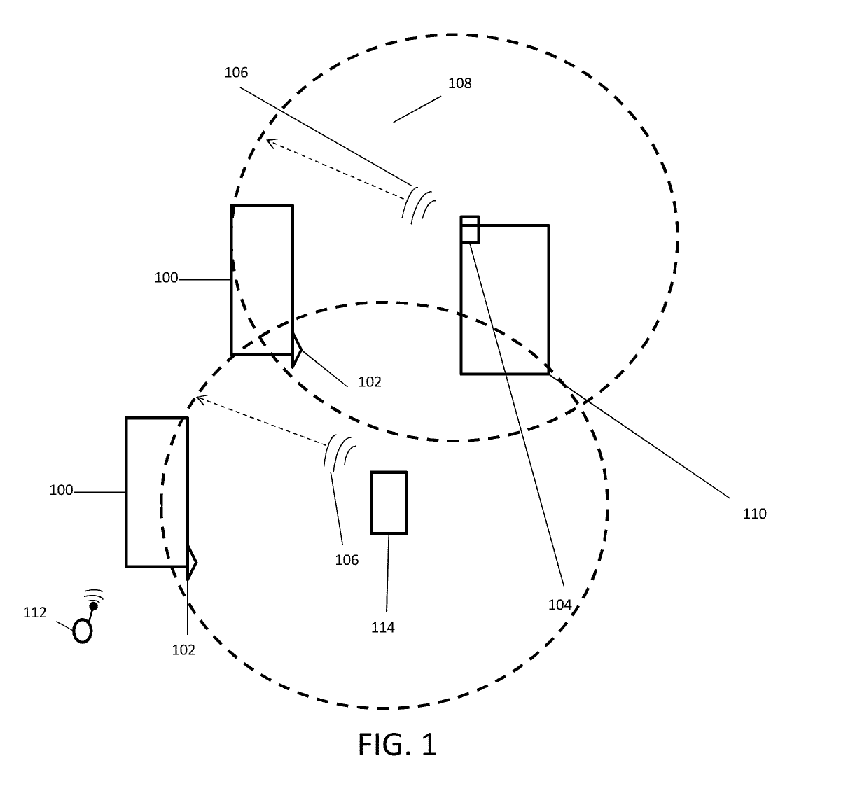

FIG. 1 is a block diagram illustrating an interaction between beacon generating devices associated with items and/or individuals moving within a facility and sensors distributed throughout the facility according to exemplary embodiments of the present disclosure. As shown in FIG. 1, beacon generating devices 104 and 114 are configured to periodically transmit beacon signals 106 encoded with data. For example beacon generating devices 104 and 114 can transmit beacon signals 106 about every 100 milliseconds (ms), 200 ms, 300 ms, or at any other predetermined period of time The beacon generating devices 104 may be affixed to assets 110 such as shopping carts, fork lifts, cranes, wheelchairs, golf carts, or any other suitable items that can be moved. The beacon generating devices 114 can be embodied in devices such as a mobile phone, portable digital assistant, laptop computer, tablet computer, or a wireless mobile device.

In exemplary embodiments, sensors 102 are geographically distributed in a facility and/or in proximity to a facility (e.g., the grounds around a facility). The sensors 102 can be communicatively coupled to the beacon generating devices 104 and 114 utilizing near field communication (NFC), Bluetooth, or low energy Bluetooth. The sensors 102 can be disposed at fixed locations 100 in the facility such as on shelves, walls, ceilings, or floors. In exemplary embodiments, the sensors 102 can detect the beacon signals 106 generated by the beacon generating devices 104 and 114 when the sensors 102 are within the range 108 of the beacon generating devices 104 and 114. For example, the beacon generating devices 104 and 114 can be configured to transmit beacon signals 106 that can be detected by the sensors 102 when the beacon generating devices 104 and 114 are within approximately 5 meters, 10 meters, or 15 meters of the sensor(s) 102. That is, the sensitivity of the sensor can be configured such that it can detect beacon signals transmitted by beacon generating devices 104 and 114 when the beacon generating devices 104 and 114 generating beacon signals 106 are approximately 0-15 meters from the sensor(s) 102. Conversely, a sensor 102 may also be configured to detect beacon signals at greater or lesser distances.

In exemplary embodiments, the sensors 102 may track a location of the assets 110 by detecting the beacon signals 106 transmitted by the beacon generating devices 104. In some embodiments, the beacon signals 106 transmitted by the beacon generating devices 104 and/or 114 can be encoded with a beacon ID. In exemplary embodiments, the sensor 102 may locate the beacon generating device 104 (or 114) by determining the strength of signal being detected. For example, if the sensor 102 is configured to detect beacon signals 106 up to 10 meters, the sensor 102 may determine the proximity of the beacon generating device 104 (or 114) transmitting the beacon signal 106 based on the strength of the beacon signal 108. The sensor 102 may be able to triangulate the location of the beacon generating device 104 (or 114) based on its proximity to the sensor 102. In other embodiments, the location of the beacon generating device 104 and 114 can be approximated based on the location(s) of the sensor(s) that detected the beacon signals from the beacon generating devices 104 and 114.

In exemplary embodiments, the plurality of sensors 102 are programmed to extract the data from the beacon signals 106 of the one or more beacon generating devices 104 and 114 upon detection of the beacon signals 106. In exemplary embodiments, the beacon generating devices 104 and 114 can encode data into the beacon signals 106. For example, in some embodiments, if the beacon generating device 114 is embodied in a mobile phone the beacon generating device 114 can encode the data being viewed on the mobile device in the beacon signals 106, and can encode user information stored in the mobile device (e.g., a phone number, user ID number, etc.). The data encoded in the beacon signals 106 can include at least one of, a beacon ID, a GPS location, a time at which the beacon signals 106 are output, a type of asset to which the beacon generating device 104 is affixed, a type of device within which the beacon generating device 114 is embodied, and a duration of time the beacon generating device 104 and 114 are within the range of a sensor 102. Receipt of the data by the sensor 102 can also be used to determine a time at which the beacon signals 106 are detected by the sensor and/or a location of the sensor 102 at which the beacon signals 106 are detected.

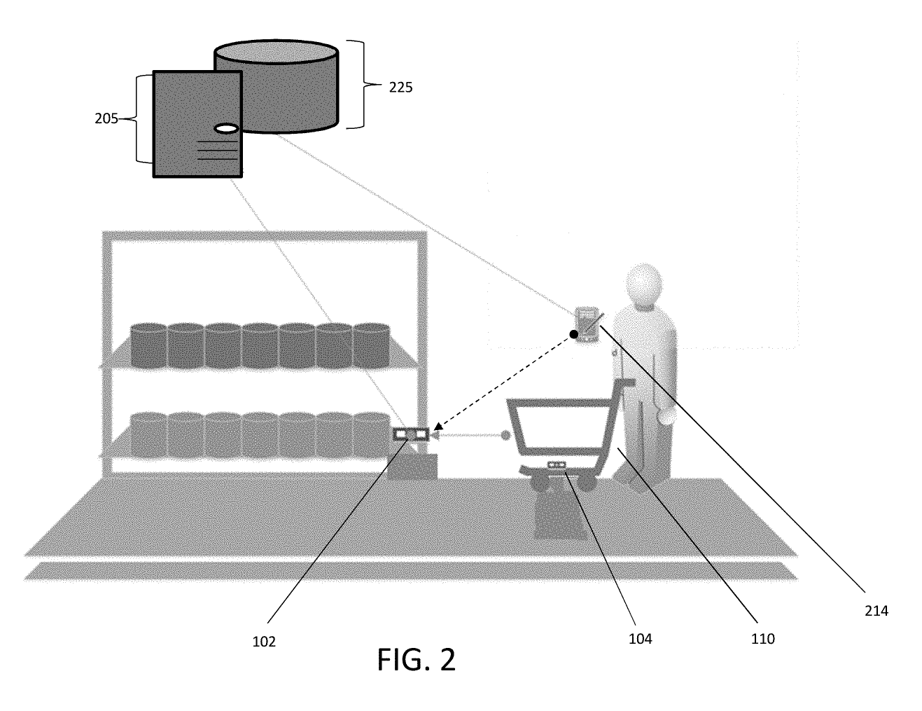

In exemplary embodiments, the plurality of sensors 102 may be communicatively coupled to a computing system (as shown in FIG. 2) including a database, server and a processor, via a WiFi receiver 112. The sensors 102 may transmit the decoded data to the computing system. In exemplary embodiments, in response to receipt of the data, the computing system is programmed to store the data in the database, and trigger, via a processor, an event associated with at least one of the beacon generating devices based on the data. In exemplary embodiments, the event may be, locating the moveable asset 110 to which at least one of the beacon generating devices 104 is affixed, determining a predictive path of the one or more beacon generating devices 104 (or 114), alerting a user of the location of at least one of the beacon generating devices 104 (or 114) based on the sensor 102 location at which a beacon signal 106 from the at least one of the beacon generating devices 104 (or 114) is detected, alerting the user of a quantity of the beacon generating devices 104 (or 114) within the range of a sensor 102, or controlling an operation of the moveable asset 110 to which the at least one of the beacon generating devices 104 is affixed.

For example, if the beacon sensors 102 affixed to or integrated with fixed assets and beacon generating devices 104 affixed to or integrated with moveable assets are disposed in a physical retail store location, the data collected from the beacon generating devices 104 (or 114) may assist in tracking moveable assets 110 to which the beacon generating device 104 is affixed, and displayed on digital maps. The moveable assets 110 may be shopping carts moving through aisles, while the fixed assets 102 may be storage shelves disposed around the store. The data extracted from the beacon generating devices 104 (or 114) may indicate how many customers are in a particular location of a store. Consequently, the data could be used to correlate the best time to schedule employees to stock an area at the best predicted times of lower customer traffic, also allow near-real time adjustment of such activities. In another example, the data extracted from the beacon generating device 104 affixed to a shopping cart may be used to calculate a predictive path of the shopping cart so that the employees of the store may be alerted about possible congestion in a certain area before it occurs.

In another example, the moveable assets 110 may be rare and highly useful assets such as a fork lift, a rocket cart or a pallet jack. The data extracted from beacon signals 108 transmitted by beacon generating devices 104 affixed to or integrated with these moveable assets 110 may be tracked to locate the moveable assets 110. The moveable assets 110, such as a fork lift or a rocket cart may be also powered down if detected that the moveable asset 110 has crossed over a certain boundary and an alert may be sent to employees about the location of the moveable asset 110.

In another example, beacon generating devices 104 may be affixed to or integrated with employee badges or the employees may carry mobile devices 114 embodied as beacon generating devices. The location of the employees may be tracked within the store. The data extracted from the beacon generating devices 104 (or 114) affixed to the employee badges may be used to schedule employee in different areas of the store to make sure each area of the store has enough coverage.

In exemplary embodiments, a user may be associated to multiple beacon generating devices 104 and/or 114. For example, the user may using a moveable asset 110 to which a beacon generating device 104 is affixed and a mobile device 114 which is embodies a beacon generating device. In exemplary embodiments, if the user is using mobile device which embodies the beacon generating device 114, the mobile device may be assigned a trip id and may be paired with the beacon generating device 104 affixed to the moveable asset 110. Pairing the mobile device and beacon generating device 104 will be further described with reference to FIG. 2. The computing system may determine that the multiple beacon generating devices from are associated with a single user and may correlate the data extracted from the beacon signals 106 generated by the multiple beacon generating devices associated with the single user.

FIG. 2 is a block diagram illustrating beacon generating devices associated with moveable items represented as a shopping cart, within a facility represented as a store, and an interaction of the beacon generating devices with sensors distributed throughout a physical store according to exemplary embodiments of the present disclosure. In exemplary embodiments, beacon sensors 102 may be disposed at fixed locations 100 distributed around various locations of a store. In exemplary embodiments, the fixed locations 100 may be storage shelves configured to display and store merchandise. In exemplary embodiments, a beacon generating device 104 may be affixed to or integrated with a moveable asset 110. The moveable asset 110 may be a shopping cart (as shown in FIG. 2). The beacon generating device 104 may transmit beacon signals periodically, e.g., every 200 ms. In other embodiments, the beacon generating device 104 may transmit beacon signals at various predetermined time periods (e.g. 100 ms, 300 ms, 550 ms). The asset 110 may be operated by a user.

In exemplary embodiments, the user may also operate a mobile device 214. The mobile device can execute an instance of an application associated with the store that connects the mobile device with a computing system 205. In exemplary embodiments, the computing system 205 can determine that the mobile device is within a store location. For example, the mobile application may be configured to scan barcodes identified on merchandise located in the store and transmit an identifier included in the scanned barcode to the computing system. In response, the computing system 205 may determine the mobile device 114 executing the mobile application is located within a store location. In other embodiments, in response to executing the mobile application the user may enter a code into the mobile device indicating the user is within a physical store location and the mobile device can transmit the code to the computing system 205. In exemplary embodiments, a beacon generating device can be embodied by the mobile phone 214 such that the mobile device 214 transmits beacon signals at various predetermined time periods. Upon detection of the beacon signal from the mobile device 214 by one of the sensors 102 in the store, the sensor can transmit the data from the beacon signal to the computing system 205, and the computing system 205 can use the data to determine that the mobile device 214 is in the store.

In exemplary embodiments, if the mobile device 214 is executing an instance of the mobile application, and in response to detecting the mobile device 214 is within the physical store location, the computing system can transmit a temporary session ID to the mobile device 214, which may be referred to herein as a trip ID. The trip ID can be used to pair the mobile device 214 with the closest beacon generating device 104. The user may be prompted to confirm the pairing of the mobile device 214 and the beacon generating device 104, via the mobile application. In other embodiments, if a beacon generating device (e.g., beacon generating device 114) is embodied in/by the mobile device 214 the trip ID may be used to correlate the beacon generating device 104 and the mobile device 214 in the database 225 located in the computing system 205.

In exemplary embodiments, the beacon sensors 102 may detect the beacon signals transmitted by the beacon generating devices and extract data based on the beacon signals. The beacon signals may include data such as a beacon ID, a time at which the beacon signals 106 are output by their respective beacon generating devices, a type of asset to which the beacon generating device 104 is affixed, a type of device within which the beacon generating device 114 is embodied, a duration of time the beacon generating devices are within a range of a sensor 102. Receipt of the beacon signals by the sensor 102 can be used to determine data, such as a time at which the beacon signals 106 are detected by the sensor 102, and/or a location of the sensor 102 at which the beacon signals 106 are detected.

In exemplary embodiments the beacon sensors 102 may transmit the extracted and/or determined data to the computing system 205. In exemplary embodiments, the computing system 205 may store the extracted and/or determined data in the database 225. The beacon sensors 102 may encrypt the data before transmitting the data to the computing system 205. In other embodiments, the beacon sensors may not encrypt the data before transmitting the data to the computing system 205.

In exemplary embodiments, the computing system 205 may analyze the extracted and/or determined data and may trigger one or more events associated with the beacon generating device 104 and/or the beacon generating device embodied by the mobile device 214 based on the analysis of the data. In exemplary embodiments, the one or more events can include, locating the moveable asset 110 to which at least the beacon generating devices 104 is affixed, determining a predictive path of the one or more beacon generating devices 104 (or 114), alerting a second user of the location of the beacon generating devices 104 and/or the mobile device 214 based on the sensor 102 location at which a beacon signal 106 from the beacon generating device 104 and/or the mobile device is detected, alerting one or more users of a quantity of the beacon generating devices within the range of a sensor 102, or controlling an operation of the moveable asset 110 to which the at least one of the beacon generating devices 104 is affixed.

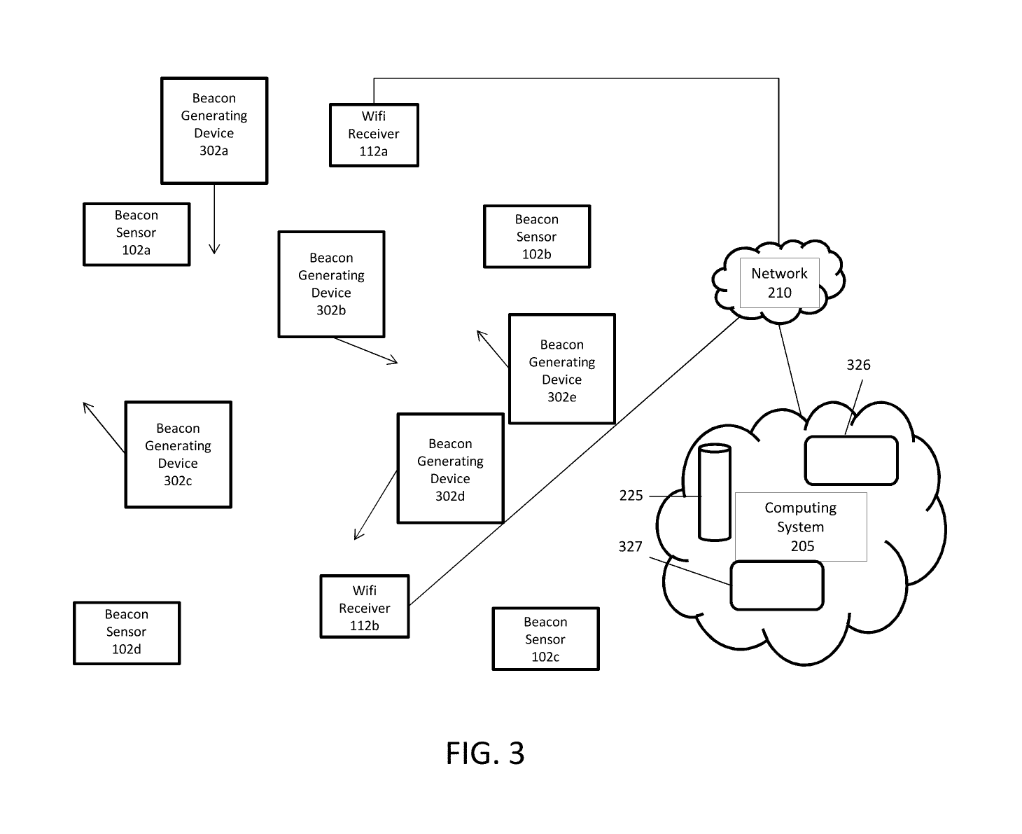

FIG. 3 is an exemplary distributed environment 300 including communicatively coupled computing systems, beacon generating devices and sensors in accordance with exemplary embodiments of the present disclosure. In exemplary embodiments, the distributed environment 300 may include the computing system 205, beacon generating devices 302a-e, sensors 102a-d, WiFi receivers 112a-b, and a network 310. The computing system 205 may include a server 326 and the database 225, communicatively coupled to the sensors 102a-d, via the WiFi receivers 112a-b and the network 310. The sensors 102a-d can be configured to detect the beacon generating devices 302a-e based on beacon signals transmitted by the beacon generating devices.

In exemplary embodiments, the beacon generating devices 302a-e may be affixed to a moveable asset 110 (as shown in FIG. 1) or embodied in a device 114 (as shown in FIG. 1) such as a mobile phone, portable digital assistant, laptop computer, tablet computer, or a wireless portable device. The beacon generating devices 302a-e may be moving in different directions as indicated by the arrows shown in FIG. 3. The beacon generating devices 302a-e may be configured to transmit beacon signals 106 (as shown in FIG. 1) encoded with data. The sensors 102a-d may detect the beacon signals 106 when they are within the range of the sensors 102a-d. The sensors 102a-d are distributed over a geographic area. In exemplary embodiments, the beacon generating devices 302a-e may move into range of different sensors 102a-d as the moveable asset 110 and/or the device 114 associated with the beacon generating device moves around the geographic area. In exemplary embodiments, at least one of the sensors 102a-d may detect beacon signals 106 transmitted by multiple beacon generating devices 302a-e. For example sensor 102a may detect beacon signals 106 transmitted by beacon generating device 202a and 202b when both are in the range of the sensor 102a.

In exemplary embodiments, the sensors 102a-d may extract the encoded data from the beacon signals 106 transmitted by the beacon generating devices 302a-e, as described herein.

In exemplary embodiments, the sensors can decode and determine data based on the beacon signals, and can transmit the decoded and determined data to the computing system 205 through the WiFi receivers 112a-b and the network 210. The server 226 in the computing system 205 may receive the decoded and determined data and store the data in the database 225. The computing system 205 can analyze the decoded and determined data stored in the database 225 and trigger one or more events based on the analysis of the data. In exemplary embodiments, the one or more events can include, locating the moveable asset to which at least one of the beacon generating devices 302a-e is affixed, determining a predictive path of the one or more beacon generating devices 302a-e, alerting a user of the location of at least one of the beacon generating devices 302a-e based on one of the plurality of sensors 102a-d location at which a beacon signal from the at least one of the beacon generating devices 302a-e is detected, alerting the user of a quantity of the beacon generating devices 302a-e within the range of at least one of a plurality of sensors 102a-d, or controlling an operation of the moveable asset to which the at least one of the beacon generating devices 302a-e is affixed. For example, at least one beacon generating device 302c may be affixed to an forklift in a warehouse. At least one sensor 102b may detect a beacon signal 106 transmitted by the beacon generating device 302c in a location in the warehouse. The sensor 102b may transmit the location of the forklift to the computing system 205, via the WiFi receiver 112b and the network 310. The computing system 205 may receive the location data via the server 326. The server 225 may store the location data in the database 225. The processor 327 of the computing system 205 may analyze the location data of the forklift stored in the database 225 and determine the forklift is in an incorrect location and needs to be powered down. The processor 327 may proceed with automatically powering down the crane.

In exemplary embodiments, a user may be associated to multiple beacon generating devices 302a-e. For example, the user may using a moveable asset to which beacon generating device 302a is affixed and a beacon generating device embodied in a mobile phone 302b. The computing system 205, via the processor 327, may determine that the multiple beacon generating devices 202a-b from are associated with a single user and may correlate the data extracted from the beacon signals generated by the multiple beacon generating devices 202a-b associated with the single user.

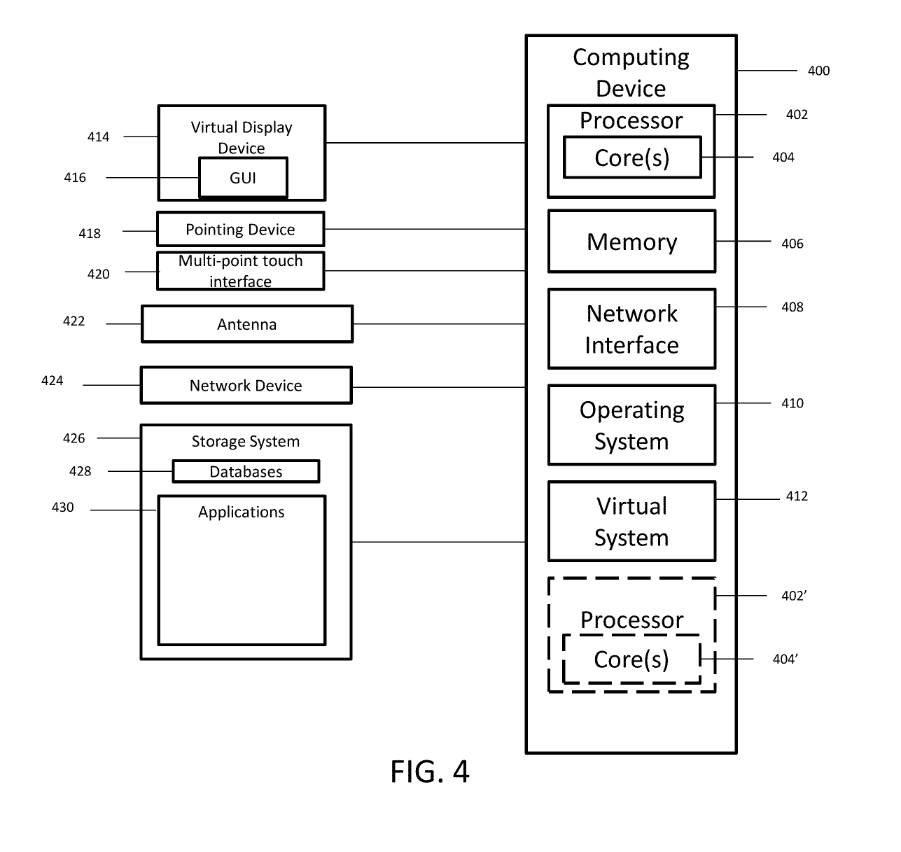

FIG. 4 is a block diagram of an example computing device for implementing exemplary embodiments of the present disclosure. In exemplary embodiments, the computing device 400 may implement embodiments of computing system 405 or the mobile device 114. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing system 400 may store computer-readable and computer-executable instructions or software (e.g., applications 430) for implementing exemplary operations of the computing device 400. The computing device 400 also includes configurable and/or programmable processor 402 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for implementing exemplary embodiments of the present disclosure. Processor 402 and processor(s) 402′ may each be a single core processor or multiple core (404 and 404′) processor.

Virtualization may be employed in the computing system 400 so that infrastructure and resources in the computing system 400 may be shared dynamically. A virtual machine 412 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 306 may include other types of memory as well, or combinations thereof.

A user may interact with the computing system 400 through a visual display device 414, such as a computer monitor, which may display one or more graphical user interfaces 416, multi touch interface 420, and a pointing device 418.

The computing device 400 may also include one or more storage devices 426, such as a hard-drive, CD-ROM, or other computer readable media, for storing data and computer-readable instructions and/or software that implement exemplary embodiments of the present disclosure (e.g., applications). For example, exemplary storage device 426 can include one or more databases 428 for storing information, such as current product data including current pricing, market rules, and price gap goals and suggested data for storing the calculated new pricing suggested data. The databases 428 may be updated manually or automatically at any suitable time to add, delete, and/or update one or more data items in the databases.

The computing device 400 can include a network interface 408 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 422 to facilitate wireless communication (e.g., via the network interface) between the computing device 300 and a network and/or between the computing device 400 and other computing devices. The network interface 108 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

The computing device 400 may run any operating system 410, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 400 and performing the operations described herein. In exemplary embodiments, the operating system 410 may be run in native mode or emulated mode. In an exemplary embodiment, the operating system 410 may be run on one or more cloud machine instances.

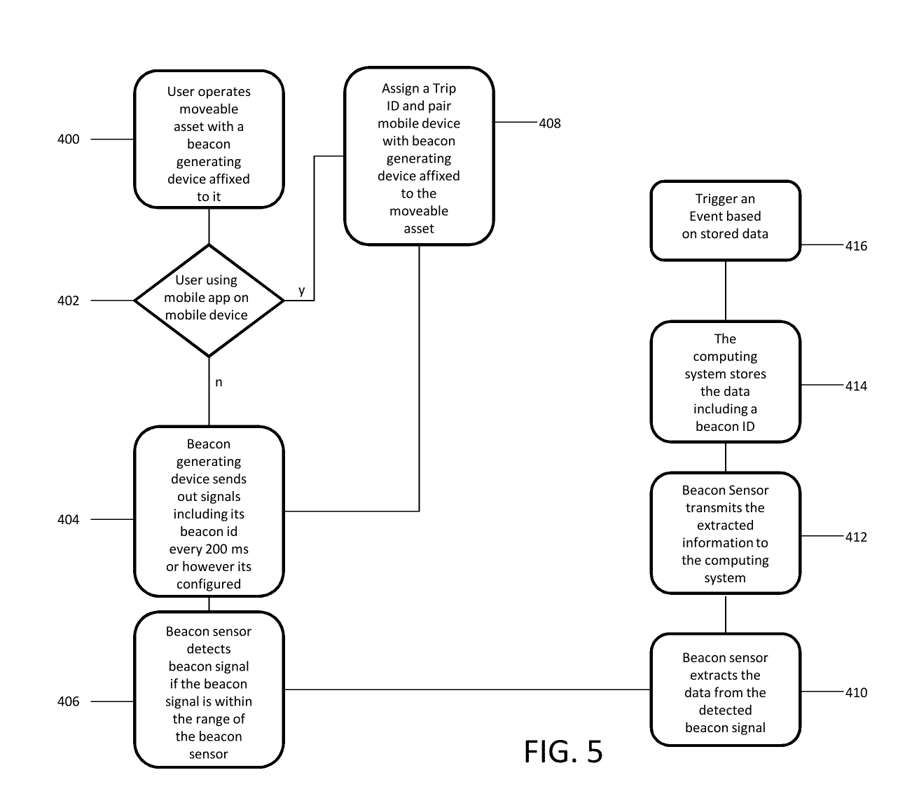

FIG. 5 is a flowchart illustrating sensing beacons signals from beacon generating devices, extracting information from the beacon generating devices and triggering an event based on the gathered information in accordance with exemplary embodiments of the present disclosure. In exemplary embodiments, in operation 500 a user may operate a moveable asset 110 with a beacon generating device 104 affixed to the moveable asset 110. In operation 502, the computing system 205 determines if the user is operating a mobile device 114 is executing an instance of a mobile application associated with the facility in which the user is located. In exemplary embodiments, if the mobile device 114 is executing an instance of the mobile application, and in response to detecting the mobile device 114 is within the facility, the mobile device 114 may be given a temporary trip ID. The trip ID may be used to pair the mobile device 114 with the closest beacon generating device 104. The user may be prompted to confirm the pairing of the mobile device 114 and the beacon generating device 104, via the mobile application. In other embodiments, if a beacon generating device is embodied in the mobile device 114 the trip ID may be used to correlate the beacon generating device 104 and the mobile device 114 in the database 225 located in the computing system 205. In exemplary embodiments, the mobile device 114 and the moveable asset 110 may be correlated together. In operation 504, in response to either determining the user is not using a mobile device executing an instance of a mobile application associated with the facility in which the user is located or in response to the mobile device being correlated to the moveable asset 110 at least one of a plurality of beacon generating devices 302a-e may transmit beacon signals with encoded data at a predetermined time period. In exemplary embodiments, the beacon generating devices 302a-e may be in motion around a geographic area. In operation 506, if the at least one of a plurality of beacon generating devices 302a-e in the range at least one of a plurality of beacon sensors 102a-d, the sensors may detect the beacon signals. The sensors 102a-d may be affixed to fixed assets and may stay in a stationary state.

In operation 510, the at least one of plurality of sensors 102a-d may extract the encoded data from the beacon signals transmitted the at least one of the beacon generating devices 202a-m, as described herein.

In operation 512, the at least one of plurality of beacon sensors 102a-d may transmit the extracted data to a computer system 205 via at least one of a plurality of WiFi receivers 112a-b. In exemplary embodiments, the sensors 102a-d may decode the extracted data. In other embodiments, the computing system 205 may decode the extracted data. In operation 414, the computing system 205 may store the extracted data in the database 225. In exemplary embodiments, the computing system 205 may analyze the data stored in the database 225. In operation 516 the computing system may trigger an event, via the processor 227 based on the analysis of the data.

In exemplary embodiments, the event can include, locating the moveable asset to which at least one of the beacon generating devices 302a-e is affixed, determining a predictive path of the one or more beacon generating devices 302a-e, alerting a user of the location of at least one of the beacon generating devices 302a-e based on one of the plurality of sensors 102a-d location at which a beacon signal from the at least one of the beacon generating devices 302a-e is detected, alerting the user of a quantity of the beacon generating devices 302a-e within the range of at least one of a plurality of sensors 102a-d, or controlling an operation of the moveable asset to which the at least one of the beacon generating devices 302a-e is affixed.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A position tracking system comprising:
a computing system including at least one processor and a non-transitory computer-readable medium;
a plurality of beacon generating devices configured to periodically transmit beacon signals encoded with data;
a plurality of sensors distributed over a geographic area to track a location of the beacon generating devices, the plurality of sensors configured to be communicatively coupled to the computing system and configured to be communicatively coupled to the plurality of beacon generating devices, the plurality of sensors including a first sensor programmed to (i) detect the beacon signals transmitted by one or more of the beacon generating devices in response to the one or more of the beacon generating devices being moved within a sensing range of the first sensor, (ii) extract the data from the beacon signals of the one or more beacon generating devices upon detection of the beacon signals, and (iii) transmit the data to the computing system,
wherein in response to receipt of the data, the computing system is programmed to store the data in the non-transitory computer-readable medium, and trigger, via the processor, an event associated with at least one of the beacon generating devices based on the data.

2. The system of claim 1, wherein the plurality of sensors configured to be communicatively coupled to the computing system via a WiFi access point.

3. The system of claim 1, wherein at least one of the beacon generating devices is embodied in a mobile phone, portable digital assistant, laptop computer, tablet computer, or a wireless portable device.

4. The system of claim 1, wherein the plurality of sensors are disposed in different location throughout a building.

5. The system of claim 1, wherein at least one of the beacon generating devices is affixed to a moveable asset.

6. The system of claim 1, wherein at least one of the beacon generating devices are associated with a user.

7. The system of claim 1, wherein the data extracted from the beacons signals output by the one or more beacon generating devices includes at least one of a time at which the beacon signals are detected, a time at which the beacon signals are output, a type of asset to which the beacon generating device is affixed, a type of device within which the beacon generating device is embodied, a duration of time the beacon signals are within the range of the first sensor, and a sensor location at which the beacon signals are detected.

8. The system of claim 7, wherein in response to the event being triggered, the computing system locates the moveable asset to which at least one of the beacon generating devices is affixed, determines a predictive path of the one or more beacon generating devices, alerts a user of the location of at least one of the beacon generating devices based on the sensor location at which a beacon signal from the at least one of the beacon generating devices is detected, alerts the user of a quantity of the beacon generating devices within the range of the first sensor, or controls an operation of the moveable asset to which the at least one of the beacon generating devices is affixed.

9. The system of claim 1, wherein in response to the event being triggered, the computing system determines that first and second beacon generating devices from the plurality of beacon generating devices are associated with a single user and correlates the data extracted from the beacon signals generated by the first beacon generating device and the second beacon generating device, wherein the first beacon generating device is affixed to a moveable asset and the second beacon generating device is embodied as a wireless portable device.

10. A method for position tracking, the method comprising:
transmitting beacon signals periodically, via a plurality of beacon generating devices, the beacon signals encoded with data;
detecting, via a first sensor of a plurality of sensors, the beacon signals transmitted by one or more of the beacon generating devices being moved within a sensing range of the first sensor, wherein the plurality of sensors are distributed over a geographic area to track a location of the beacon generating devices, configured to be communicatively coupled to the computing system and configured to be communicatively coupled to the plurality of beacon generating devices;
extracting, via the first sensor, data from the beacon signals of the one or more beacon generating devices upon detection of the beacon signals;
transmitting, via the first sensor, the data to the computing system;
in response to receipt of the data, a computing system including a processor and a non-transitory computer readable medium, storing the data in the non-transitory computer-readable medium; and
triggering, via the processor, an event associated with at least one of the beacon generating devices based on the data.

11. The method of claim 10, wherein the plurality of sensors configured to be communicatively coupled to the computing system via a WiFi access point.

12. The method of claim 10, wherein at least one of the beacon generating devices is embodied in a mobile phone, portable digital assistant, laptop computer, tablet computer, or a wireless portable device.

13. The method of claim 10, wherein the plurality of sensors are disposed in different location throughout a building.

14. The method of claim 10, wherein at least one of the beacon generating devices is affixed to a moveable asset.

15. The method of claim 10, wherein at least one of the beacon generating devices are associated with a user.

16. The method of claim 10, wherein the data extracted from the beacons signals output by the one or more beacon generating devices includes at least one of a time at which the beacon signals are detected, a time at which the beacon signals are output, a type of asset to which the beacon generating device is affixed, a type of device within which the beacon generating device is embodied, a duration of time the beacon signals are within the range of the first sensor, and a sensor location at which the beacon signals are detected.

17. The method of claim 16, further comprising in response to the event being triggered, the computing system locating the moveable asset to which at least one of the beacon generating devices is affixed, determining a predictive path of the one or more beacon generating devices, alerting a user of the location of at least one of the beacon generating devices based on the sensor location at which a beacon signal from the at least one of the beacon generating devices is detected, alerting the user of a quantity of the beacon generating devices within the range of the first sensor, or controlling an operation of the moveable asset to which the at least one of the beacon generating devices is affixed.

18. The method of claim 10, further comprising in response to the event being triggered, the computing system determining that first and second beacon generating devices from the plurality of beacon generating devices are associated with a single user and correlating the data extracted from the beacon signals generated by the first beacon generating device and the second beacon generating device, wherein the first beacon generating device is affixed to a moveable asset and the second beacon generating device is embodied as a wireless portable device.
